(19) United States
(12) Patent Application Publication
(10) Pub. No.: US 2020/0168112 A1
(43) Pub. Date: May 28, 2020

(54) DEVICE AND METHOD FOR LANDING ASSISTANCE FOR AN AIRCRAFT IN CONDITIONS OF REDUCED VISIBILITY

(71) Applicant: THALES, COURBEVOIE (FR)

(72) Inventors: Yoan VEYRAC, MERIGNAC (FR); Patrick GARREC, MERIGNAC (FR); Pascal CORNIC, BREST (FR)

(21) Appl. No.: 16/691,046

(22) Filed: Nov. 21, 2019

(30) Foreign Application Priority Data
Nov. 22, 2018 (FR) 1871696

(51) Int. Cl. G08G 5/02; G08G 5/00; B64D 45/08; G01C 23/00; B64D 43/00; G06K 9/00; G06N 3/08; H04W 4/18

(52) U.S. Cl. CPC G08G 5/025; G08G 5/0086; G08G 5/0021; B64D 45/08; H04W 4/185; B64D 43/00; G06K 9/00637; G06N 3/08; G01C 23/005

(57) ABSTRACT

With the device detecting and positioning the runway with respect to the aircraft, it includes at least: a radar sensor; a radar image collection system, collecting and tagging images acquired by radar sensors carried by aircraft during phases of landing on the runway under nominal conditions, the tagging of an image giving information about the positioning of the runway with respect to the aircraft carrying the sensor capturing the image; a neural network trained on the basis of the images that are tagged and collected during landings on the runway under nominal conditions, the network estimating the position of the runway with respect to the aircraft by virtue of the radar images acquired by the sensor during the current landing; a functional block utilizing and formatting the data about the positioning of the runway with respect to the aircraft and coming from the neural network in order to format the data in an adapted interface.

### CROSS-REFERENCE TO RELATED APPLICATIONS

This application claims priority to foreign French patent application No. FR 1871696, filed on Nov. 22, 2018, the disclosure of which is incorporated by reference in its entirety.

### FIELD OF THE INVENTION

The present invention relates to a device and to a method for landing assistance in conditions of reduced visibility.

The technical field of the invention is that of detecting and recognizing an environment in relation to the position of an observer. The primary field of use is that of radar, for landing assistance applications. This invention more precisely targets “EVS” (enhanced vision system) landing assistance systems. The invention could apply to other sensors (for example optical or electro-optical sensors).

### BACKGROUND

The invention notably addresses the problem of assisting the landing of aircraft on a runway in conditions of reduced visibility, in particular caused by challenging weather conditions, for example in the case of fog. The standards impose rules for achieving visibility during the landing phase. These rules are reflected in decision thresholds that refer to the altitude of the aeroplane during the descent phase thereof. At each of these thresholds, identified visual markers must be acquired in order to continue the landing manoeuvre, without which said manoeuvre has to be abandoned. Abandoned landing manoeuvres represent a real problem for air traffic control and for flight planning. It is necessary, before take-off, to estimate the ability to be able to land at a destination on the basis of weather forecasts, these being more or less reliable, and where applicable to provide backup solutions.

The problem of landing aircraft in conditions of reduced visibility has been subject to the development of numerous techniques that are nowadays used.

One of these techniques is the instrument landing system (ILS). The ILS system is based on a radiofrequency device installed on the ground, on the runway, and a compatible instrument situated on board the aircraft. The use of such a guidance system requires expensive devices and a specific qualification for the pilots. It is also not able to be installed at all airports. This system is not widespread and it is in the phase of being removed from use.

Another alternative is GPS landing assistance. Although it exhibits sufficient precision, this solution is too unreliable since it may easily—intentionally or unintentionally—be subject to jamming. The integrity thereof is not guaranteed.

Lastly, an enhanced viewing technique is also used (enhanced vision system, EVS). The principle is that of using sensors with a better performance than the pilot's eye in degraded weather conditions, and of superimposing the collected information in the pilot's field of view by way of a head-up display or on the visor of a headset worn by the pilot. This technique is essentially based on using sensors to detect the radiation from the lamps positioned along the runway and on the approach ramp. Incandescent lamps produce visible light, but they also emit in the infrared range. Sensors in the infrared range make it possible to detect this radiation, and the detection range is better than that of a human in the visible range in degraded weather conditions. Improving visibility therefore to a certain extent makes it possible to improve approach phases and to limit abandoned approaches. However, this technique is based on stray infrared radiation from the lamps present close to the runway. In order to ensure that the lamps have a long life, the current trend is to replace incandescent lamps with LED lamps. These have a narrower spectrum in the infrared range. One collateral effect is therefore that of bringing about technical obsolescence of infrared sensor-based EVS systems.

One alternative to infrared sensors is that of acquiring images by way of a radar sensor in the centimetre or millimetre band. Certain frequency bands chosen outside of the absorption peaks of water vapour exhibit very low sensitivity to challenging weather conditions. Such sensors therefore make it possible to produce an image through fog for example. However, even though these sensors have a fine distance resolution, they have an angular resolution that is far coarser than optical solutions. The resolution is linked directly to the size of the antennas that are used, and it is often too coarse to achieve precise positioning of the runway at a distance sufficient to perform recalibration manoeuvres.

There is therefore a need for new technical solutions for guiding the approach manoeuvre for the purpose of landing in conditions of reduced visibility.

### SUMMARY OF THE INVENTION

One aim of the invention is notably to allow such guidance in conditions of reduced visibility. To this end, one subject of the invention is a landing assistance device for an aircraft for joining up with a given runway, said device detecting and positioning said runway with respect to said aircraft, and comprising at least:
A radar sensor;
A radar image collection system, collecting and tagging radar images acquired by radar sensors carried by aircraft during phases of landing on said runway under nominal conditions, said tagging of an image giving information about the positioning of said runway with respect to the aircraft carrying the sensor capturing said image;
A learning network trained on the basis of the images that are tagged and collected during landings on said runway under nominal conditions, said network estimating the position of said runway with respect to said aircraft by virtue of the radar images acquired by said sensor during the current landing;
A functional block utilizing and formatting the data about the positioning of said runway with respect to said aircraft and coming from the learning network in order to format said data in an adapted interface.

With said interface making it possible to display said runway or symbols representing it, said device comprises for example a display system linked to said functional formatting block. This display system is for example a head-up viewing system or a headset.

Said interface for example supplies flight commands allowing said aircraft to join up with a nominal landing trajectory.

In one particular embodiment, for an aircraft carrying an image acquisition radar sensor, tagging said images comprises at least one of the following indications:
Date of acquisition of the image in relation to the time of said carrier touching down on the runways;
Location of said carrier at the time when the image is captured:
Absolute: GPS position;
Relative with respect to the runway: inertial measurement unit;
Altitude of said carrier;
Attitude of said carrier;
Velocity vector of said carrier (acquired by said radar sensor as a function of its velocity with respect to the ground);
Acceleration vector of said carrier (acquired by said radar sensor as a function of its velocity with respect to the ground);
Position, relative to said carrier, of the runway and of reference structures, acquired by precise-location optical means.

With said collection system comprising a memory for storing said tagged radar images, said memory is for example updated throughout the nominal landings performed by a set of aircraft on said runway. Said storage memory is for example shared by several aircraft equipped with said device for the learning of said learning network.

Said learning network supplies for example a performance indicator that quantifies the positioning precision of said runway with respect to said aircraft, this indicator being acquired through correlation between the image of said runway as calculated by said learning network and a reference image.

The invention also relates to a landing assistance method for an aircraft for joining up with a given runway, said method detecting and positioning said runway with respect to said aircraft, and comprising at least:
A first step of acquiring a first series of radar images by way of a radar sensor;
A second step of estimating the position of said runway with respect to said aircraft by way of a learning network, the learning of said learning network being performed on a set of radar images of said runway that are collected during nominal or possible aircraft landing phases, said images being tagged with at least one item of information about the position of said runway with respect to said aircraft;
said first and second steps being repeated until joining up with said runway.

Said estimated position is for example transmitted to an interface for displaying the runway or representative symbols by way of a display system.

Said estimated position is for example transmitted to an interface supplying flight commands allowing said aircraft to join up with a nominal landing trajectory.

In one particular mode of implementation, for an aircraft carrying an image acquisition radar sensor, tagging said images comprises at least one of the following indications:
Date of acquisition of the image in relation to the time of said carrier touching down on the runways;
Location of said carrier at the time when the image is captured:
Absolute: GPS position;
Relative with respect to the runway: inertial measurement unit;
Altitude of said carrier;
Attitude of said carrier;
Velocity vector of said carrier (acquired by said radar sensor as a function of its velocity with respect to the ground);
Acceleration vector of said carrier (acquired by said radar sensor as a function of its velocity with respect to the ground);
Position, relative to said carrier, of the runway and of reference structures, acquired by precise-location optical means.

With said collected and tagged radar images being stored in a storage memory, said memory is for example updated throughout the nominal landings performed by a set of aircraft on said runway. Said storage memory is for example shared for the learning of learning networks of several aircraft.

### BRIEF DESCRIPTION OF THE DRAWINGS

Other features and advantages of the invention will become apparent with the aid of the following description, given with reference to the appended drawings in which:

FIG. 1 shows an exemplary embodiment of a device according to the invention;

FIG. 2 shows an exemplary implementation of a landing assistance method according to the invention.

### DETAILED DESCRIPTION

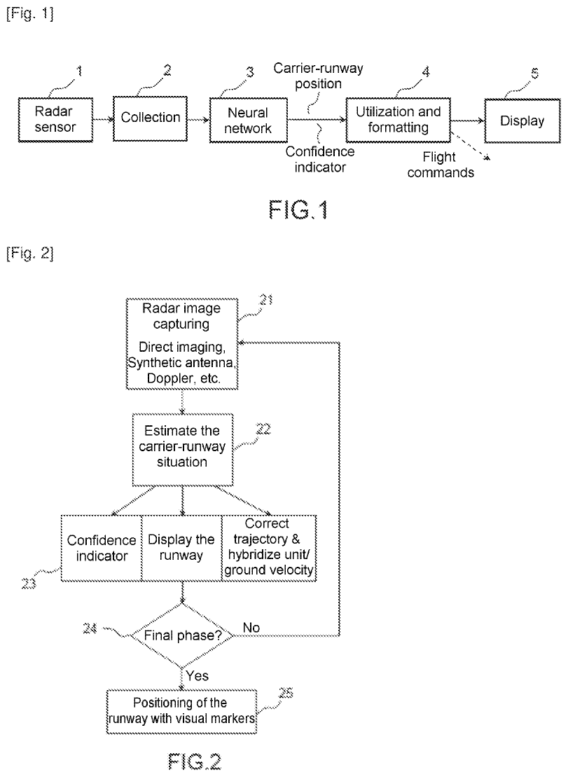

FIG. 1 shows the components of a device according to the invention. The device assists an aircraft in landing by detecting and positioning the runway with respect to the aircraft. It comprises at least:
A radar sensor 1 carried by said aircraft;
A radar image collection system 2, tagging and storing radar images acquired by the sensor 1 and by sensors of other aircraft during landing phases in clear weather, provided by the pilot and/or the navigation instruments of said aircraft; A learning network that may be for example a neural network 3 trained on the basis of the collection of radar images, that is to say on the basis of the radar images acquired during nominal landings (a nominal landing being a successful landing performed during the day or at night, in clear weather, rain, fog or notably snow, this landing having been performed successfully without any incidents) and the function of which is to estimate the position of the runway with respect to the carrier by virtue of the radar images acquired in real time by the radar sensor 1 (that is to say acquired during the current landing), these images being stored in a database associated with the collection system 2;
Another functional block 4 utilizing and formatting the data from the neural network in order to format these data in an adapted interface, this interface being able to display the runway or symbols representing it, or even to supply flight commands for joining up with the nominal landing trajectory.

The device comprises for example a system 5 for displaying the runway, visual markers and relevant navigation data integrated into the pilot's field of view via a head-up display (HUD) viewing system or a headset, any other viewing system being possible.

The radar sensor, carried by the aircraft, operates for example in the centimetre band or in the millimetre band. It makes it possible to position the carrier with respect to a runway on which said carrier wishes to land, independently of the visibility conditions of the pilot.

The radar images are supplied by the sensor at each landing phase, thereby making it possible to continuously enrich the database of the collection system 2. As indicated above, these radar data are acquired during nominal landing manoeuvres, in clear weather, during the day or at night. This acquisition is also performed in various possible aerology and manoeuvring conditions (various types of wind, various angles of arrival, various approach gradients), the information about all of these conditions being contained in the tagging of the images. Once the landing has ended, the radar data acquired during the landing phase are recorded in the database and tagged as forming part of a nominal or possible landing manoeuvre. The tagging comprises at least this nominal landing information, but it may advantageously be expanded to the following additional information depending on the availability on the carrier:
Date of acquisition of the image in relation to the time of the wheels of the carrier touching down on the runways;
Location of the carrier at the time when the image is captured:
Absolute: GPS position;
Relative with respect to the runway: inertial measurement unit;
Altitude of the carrier;
Attitude of the carrier;
Velocity vector of the carrier (acquired by the radar 1 as a function of its velocity with respect to the ground);
Acceleration vector of the carrier (acquired by the radar 1 as a function of its velocity with respect to the ground);
Position, relative to the carrier, of the runway and of reference structures, acquired by precise-location optical means.

Once they have been tagged, these radar images are used by the neural network 3. They serve to train said neural network. More precisely, the neural network learns the runway on the basis of all of the images that are stored and tagged in the database of the collection system 2. Once it has been trained, the neural network 3 is capable, on the basis of a series of radar images, of positioning the runway and its environment with respect to the carrier, more particularly of positioning the landing point. The series of images at the input of the neural network are the images captured by the radar 1 in the current landing phase.

It is then possible, for the functional block 4, to estimate and to correct the difference in the corresponding trajectory (trajectory of the carrier in the current landing) with respect to a nominal or possible landing trajectory. It is also possible to display the runway in the pilot's field of view by way of the display system 5. The precision of this positioning and of the trajectory correction are more precise the fuller the base of learning images (stored by the collection system 2).

This base of learning images may be fed collectively by all of the aircraft that use the same system. Thus, all of the aircraft that land on one and the same runway may enrich this base with the radar images acquired by their radars. Advantageously, each aircraft then benefits from an exhaustive and up-to-date base.

Given that each database is updated from several on-board devices, it is necessary to take into account the biases of each device contributing to a database. These biases are linked in particular to the technological differences on the radar of each device and to installation discrepancies. The recorded data (radar images) are therefore for example also tagged with the information of the carrier, so as to be able to identify and correct the biases. These biases are corrected by the neural network, which utilizes the tagged images so as to position the runway and its environment with respect to the carrier.

The neural network 3 may also supply a performance indicator for quantifying the positioning and guidance precision of the carrier in real time during landing phases, so as to achieve a degree of confidence. This performance indicator is for example an index of correlation between the image rendered by the neural network and in which the carrier is positioned and a reference image, such as a recorded image or a digital terrain model (DTM).

The convergence and performance metrics associated with the database of each recorded runway may be calculated. They make it possible to evaluate the quality of the guidance able to be achieved by the device on each of the runways.

This quality depends on the size of the database, but also on the environment of the runways, on the quality of the noteworthy structures that have an all the greater weight in the learning of the neural network. Noteworthy structures such as the runway itself or else the various approach lamps are systematically encountered. Other elements specific to the environment of each runway have an important role in improving the positioning; these specific elements are for example the fencing of the airport area, antennas or else buildings.

The device according to the invention may be provided with a function for viewing the neural network in order to guarantee the observability thereof. This viewing function makes it possible notably to view the highly weighted reference structures and schemes that dominate recognition and marking.

The acquired radar images may be direct radar images or SAR (“synthetic aperture radar”) images. The latter make it possible to refine angular precision while at the same time benefiting from the change in viewing angle of the movement of the carrier.

In one particular embodiment of a device according to the invention, all of the components thereof (radar sensor 1, radar image collection system 2, neural network 3, block 4 for utilizing and formatting the data from the neural network, and display system 5) are on the aircraft. The database of the collection system is regularly enriched with the tagged images from the collection systems of other aircraft. The neural network maintains or improves its learning of the runway or runways as this database is enriched. The learning takes place outside of the landing phases when the neural network is not called upon to render the parameters of the runway. The learning takes place on the tagged images as are stored in the database of the device.

The databases of the collection systems may be updated by any communication means. Each update is performed for example after each nominal landing, at least with the images of the carrier that has just landed. Rules for updating on the basis of the images from the collection systems of other aircraft may be established in particular in order to define the periodicity of these updates and the update modes that are used, notably in terms of the communication means.

The collection system 2 and the neural network and the block 4 for utilizing the data are for example integrated into the flight computer of the aircraft.

In another embodiment, the collection system 2 is not on board the carrier, in particular its storage memory. The tagging function is performed for example in-flight with the captured radar images. The tagged images are sent from each aircraft to the collection system and the storage memory by appropriate communication means, in real time throughout the landing or in a deferred manner, for example after each landing. In this other embodiment, the learning by the neural network is performed on the ground. In this case as well, one and the same memory for storing the tagged images may be shared by several aircraft. Advantageously, the shared storage memory thus comprises a larger amount of data, promoting learning.

The landing method according to the invention, implemented for example by a device of the type in FIG. 1, comprises the steps described below with reference to FIG. 2 for a given runway.

Two preliminary steps, not shown, relate to collecting images and learning the runway on the basis of the collected images, as described above.

A first step 21 captures a first series of radar images, these images being radar images or SAR images acquired by the radar sensor 1 on board the aircraft. Each radar image is tagged in accordance with the images already recorded in the collection system 2.

In the second step 22, the situation of the carrier with respect to the runway and its environment is estimated by way of the neural network, on the basis of the series of acquired radar images. It is possible to provide a series consisting of a single radar image, the estimation being able to be performed on the basis of a single image.

In a third step 23, the estimation supplied by the neural network 3 is utilized, this utilization being performed by way of the functional block 4 for example. Said functional block supplies the formatted data for display (performed by the display system 5) and in order to supply the flight commands for correcting the trajectory. It also makes it possible to present the confidence indicator calculated by the neural network in a usable form.

At the end of this third step 24, if the aeroplane is not in the final landing phase (that is to say at the point of joining up with the runway), the method loops back to the first step 21 at which a new series of radar images is acquired. In the opposite case, if the aeroplane is in the final landing phase, the final positioning of the aircraft with respect to the runway is reached 25 with the definitive landing trajectory.

Advantageously, the landing by way of a device according to the invention is particularly robust to one-off variations in the environment, for example the presence of vehicles or seasonal vegetation, which pose problems for fixed algorithms. The invention furthermore adapts to long-term variations in the environment, such as new structures or infrastructures for example, by integrating these elements into the learning base.

1. A landing assistance device for an aircraft for joining up with a given runway, wherein detecting and positioning said runway with respect to said aircraft, it comprises at least:
a radar sensor;
a radar image collection system, collecting and tagging radar images acquired by radar sensors carried by aircraft during phases of landing on said runway under nominal conditions, said tagging of an image giving information about the positioning of said runway with respect to the aircraft carrying the radar sensor capturing said image;
a learning network trained on the basis of the images that are tagged and collected during landings on said runway under nominal conditions, said network estimating the positioning of said runway with respect to said aircraft by virtue of the radar images acquired by said radar sensor during the current landing;
a functional block utilizing and formatting the data about the positioning of said runway with respect to said aircraft and coming from the learning network in order to format said data in an adapted interface.

2. The device according to claim 1, wherein with said interface making it possible to display said runway or symbols representing it, said device comprises a display system linked to said functional formatting block.

3. The device according to claim 2, wherein the display system is a head-up viewing system or a headset.

4. The device according to claim 1, wherein said interface supplies flight commands allowing said aircraft to join up with a nominal landing trajectory.

5. The device according to claim 1, wherein for an aircraft carrying an image acquisition radar sensor, tagging said images comprises at least one of the following indications:
date of acquisition of the image in relation to the time of said carrier touching down on the runways;
location of said carrier at the time when the image is captured:
absolute: GPS position;
relative with respect to the runway: inertial measurement unit;
altitude of said carrier;
attitude of said carrier;
velocity vector of said carrier (acquired by said radar sensor as a function of its velocity with respect to the ground);
acceleration vector of said carrier (acquired by said radar sensor as a function of its velocity with respect to the ground);
position, relative to said carrier, of the runway and of reference structures, acquired by precise-location optical means.

6. The device according to claim 1, wherein with said collection system comprising a memory for storing said tagged radar images, said memory is updated throughout the nominal landings performed by a set of aircraft on said runway.

7. The device according to claim 6, wherein said storage memory is shared by several aircraft equipped with said device for the learning of said learning network.

8. The device according to claim 1, wherein said learning network supplies a performance indicator that quantifies the positioning precision of said runway with respect to said aircraft, this indicator being acquired through correlation between the image of said runway as calculated by said learning network and a reference image.

9. The device according to claim 1, wherein said learning network is a neural network.

10. A landing assistance method for an aircraft for joining up with a given runway, wherein detecting and positioning said runway with respect to said aircraft, it comprises at least:
a first step of acquiring a first series of radar images by way of a radar sensor;
a second step of estimating the position of said runway with respect to said aircraft by way of a learning network, the learning of said learning network being performed on a set of radar images of said runway that are collected during nominal or possible aircraft landing phases, said images being tagged with at least one item of information about the position of said runway with respect to said aircraft;
said first and second steps being repeated until joining up with said runway.

11. The method according to claim 10, wherein said estimated position is transmitted to an interface for displaying the runway or representative symbols by way of a display system.

12. The method according to claim 11, wherein the display system is a head-up viewing system or a headset.

13. The method according to claim 10, wherein said estimated position is transmitted to an interface supplying flight commands allowing said aircraft to join up with a nominal landing trajectory.

14. The method according to claim 10, wherein for an aircraft carrying an image acquisition radar sensor, tagging said images comprises at least one of the following indications:
date of acquisition of the image in relation to the time of said carrier touching down on the runways;
location of said carrier at the time when the image is captured:
absolute: GPS position;
relative with respect to the runway: inertial measurement unit;
altitude of said carrier;
attitude of said carrier;
velocity vector of said carrier (acquired by said radar sensor as a function of its velocity with respect to the ground);
acceleration vector of said carrier (acquired by said radar sensor as a function of its velocity with respect to the ground);
position, relative to said carrier, of the runway and of reference structures, acquired by precise-location optical means.

15. The method according to claim 10, wherein with said collected and tagged radar images being stored in a storage memory, said memory is updated throughout the nominal landings performed by a set of aircraft on said runway.

16. The method according to claim 15, wherein said storage memory is shared for the learning of learning networks of several aircraft.
